(19) United States
(12) Patent Application Publication
(10) Pub. No.: US 2021/0116547 A1
(43) Pub. Date: Apr. 22, 2021

(54) FULL-DUPLEX OPTICAL DATA LINK FOR LIDAR DEVICES

(71) Applicant: DiDi Research America, LLC, Mountain View, CA (US)

(72) Inventors: Yue Lu, Mountain View, CA (US); Yonghong Guo, Mountain View, CA (US); Chao Wang, Mountain View, CA (US); Youmin Wang, Mountain View, CA (US)

(21) Appl. No.: 16/658,018

(22) Filed: Oct. 18, 2019

(51) Int. Cl. G01S 7/481; G01S 7/491

(52) U.S. Cl. CPC G01S 7/4817; G01S 17/936; G01S 7/4914; G01S 7/4811

(57) ABSTRACT

Embodiments of the disclosure provide a sensing device. The sensing device includes a first optical transceiver disposed on a first part of the sensing device and a second optical transceiver disposed on a second part of the sensing device. The first and second optical transceivers are configured to be wirelessly coupled to each other and simultaneously transmit signals to each other. The first part is configured to rotate relative to the second part.

### TECHNICAL FIELD

The present disclosure relates to light detection and ranging (LiDAR) devices, and more particularly to, full-duplex data links using non-interfering light signals for information exchange within a LiDAR device.

### BACKGROUND

LiDAR systems have been widely used in autonomous driving and producing high-definition maps. For example, LiDAR systems measure distance to a target by illuminating the target with pulsed laser light and measuring the reflected pulses with a sensor. Differences in laser return times and wavelengths can then be used to make digital three-dimensional (3D) representations of the target. The laser light used for LiDAR scan may be ultraviolet, visible, or near infrared. Because using a narrow laser beam as the incident light from the scanner can map physical features with very high resolution, a LiDAR system is particularly suitable for applications such as sensing in autonomous driving and high-definition map surveys.

A typical LiDAR system normally includes a rotating (scanning) part that can be used for emitting the pulsed laser light and receiving the reflected pulses over a wide range of scanning angles, and a stationary part fixed to a vehicle and used for providing control signals and power to the rotating part and receiving sensing signals obtained by the rotating part. The sensing signals and the control signals need to be communicated between the rotating part and the stationary part. Typical methods for signal communication between the rotating part and the stationary part include “wired” methods such as using slip rings to make physical connections between the rotating and stationary parts and “wireless” methods such as using electrical or magnetic signals to establish connections through electromagnetic coupling. However, these conventional methods have drawbacks. For example, the slip rings normally have limited lifetimes because of the abrasion caused by the physical contact between the two parts. Because the rotation speed of a typical LiDAR system is quite high, the lifetime of a slip ring device within a LiDAR system can be as short as 100 hours. On the other hand, using electromagnetic coupling to transmit electrical or magnetic signals suffers from low transmission speed as well as signal interference problems. For example, data transmission speed of a typical electromagnetic device used for transmitting/receiving digital information within a LiDAR system is less than 10M bit/s. In addition, the signal-to-noise ratio is normally quite low due to strong interference. Thus, it is challenging for the conventional signal communication methods to meet the increasing demand for a faster signal transmission rate and a longer lifetime required by a more advanced LiDAR system.

Embodiments of the disclosure address the above problems by providing full-duplex optical data links for LiDAR devices.

### SUMMARY

Embodiments of the disclosure provide a sensing device. The sensing device includes a first optical transceiver disposed on a first part of the sensing device and a second optical transceiver disposed on a second part of the sensing device. The first and second optical transceivers are configured to be wirelessly coupled to each other and simultaneously transmit signals to each other. The first part is configured to rotate relative to the second part.

Embodiments of the disclosure also provide a method for information exchange within a sensing device. The method includes transmitting, by a first optical transceiver disposed on a first part of the sensing device, information related to a sensing signal to a second optical transceiver disposed on a second part of the sensing device and simultaneously receiving, by the first optical transceiver, signals transmitted from the second optical transceiver. The first and second optical transceivers are configured to be wirelessly coupled to each other, and the first part is configured to rotate relative to the second part.

Embodiments of the disclosure also provide a sensing system. The sensing system includes a first part and a second part. The first part includes at least one optical sensor configured to scan a surrounding environment of the sensing device by emitting an optical signal to an object in the surrounding environment and at least one photo detector configured to receive a returning optical signal reflected by the object to generate a sensing signal. The first part also includes a first optical transceiver configured to communicate information related to the sensing signal with the second part of the sensing device. The second part of the sensing device includes a second optical transceiver configured to wirelessly coupled to the first optical transceiver to communicate the information related to the sensing signal. The first and second optical transceivers are configured to simultaneously transmit data to each other, and the first part is configured to rotate relative to the second part.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary vehicle equipped with a LiDAR sensing system, according to embodiments of the disclosure.

FIG. 2 illustrates a block diagram of an exemplary LiDAR sensing device, according to embodiments of the disclosure.

FIG. 3 illustrates a schematic diagram of an exemplary sensing device having a wireless connection between its first and second parts using full-duplex optical data links, according to embodiments of the disclosure.

FIG. 4 illustrates a schematic diagram of another exemplary sensing device having a wireless connection, according to embodiments of the disclosure.

FIG. 5 is a flow chart of an exemplary method for information exchange within a sensing device, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

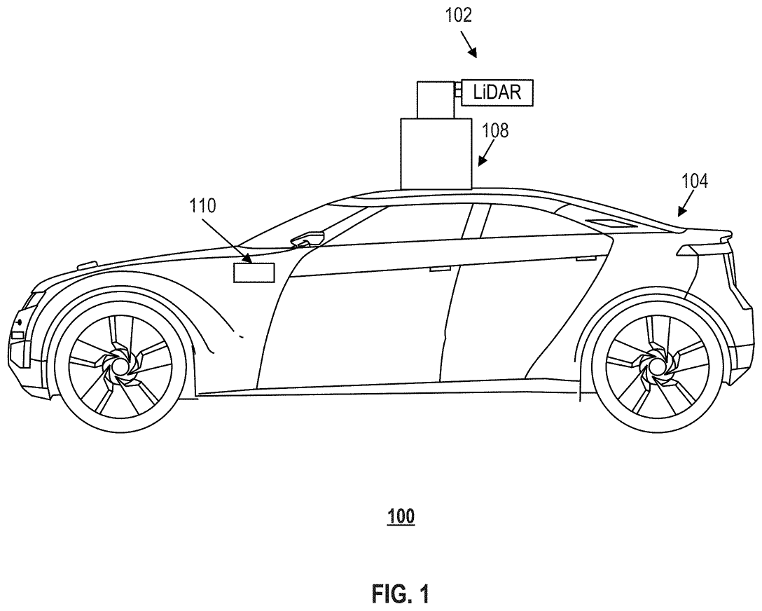

FIG. 1 illustrates a schematic diagram of an exemplary vehicle 100 equipped with a LiDAR system 102, according to embodiments of the disclosure. Consistent with some embodiments, vehicle 100 may be an autonomous driving vehicle or a survey vehicle configured for acquiring data for constructing a high-definition map or 3D buildings and city modeling.

As illustrated in FIG. 1, vehicle 100 may be equipped with LiDAR system 102 mounted to a body 104 via a mounting structure 108. Mounting structure 108 may be an electro-mechanical device installed or otherwise attached to body 104 of vehicle 100. In some embodiments of the present disclosure, mounting structure 108 may use screws, adhesives, or another mounting mechanism. Vehicle 100 may be additionally equipped with a sensor 110 inside or outside body 104 using any suitable mounting mechanisms. Sensor 110 may include sensors used in a navigation unit, such as a Global Positioning System (GPS) receiver and one or more Inertial Measurement Unit (IMU) sensors. It is contemplated that the manners in which LiDAR system 102 or sensor 110 can be equipped on vehicle 100 are not limited by the example shown in FIG. 1 and may be modified depending on the types of LiDAR system 102 and sensor 110 and/or vehicle 100 to achieve the desirable sensing performance.

Consistent with some embodiments, LiDAR system 102 and sensor 110 may be configured to capture data as vehicle 100 moves along a trajectory. For example, a transmitter of LiDAR system 102 is configured to scan the surrounding and acquire point clouds. LiDAR system 102 may include one or more LiDAR sensing devices configured to measure distance to a target by illuminating the target with pulsed laser beams and measuring the reflected pulses h a receiver. The laser beams used by LiDAR system 102 may be ultraviolet, visible, or near infrared. In some embodiments of the present disclosure, LiDAR system 102 may capture point clouds. As vehicle 100 moves along the trajectory, LiDAR system 102 may continuously capture data. Each set of data captured at a certain time range is known as a data frame.

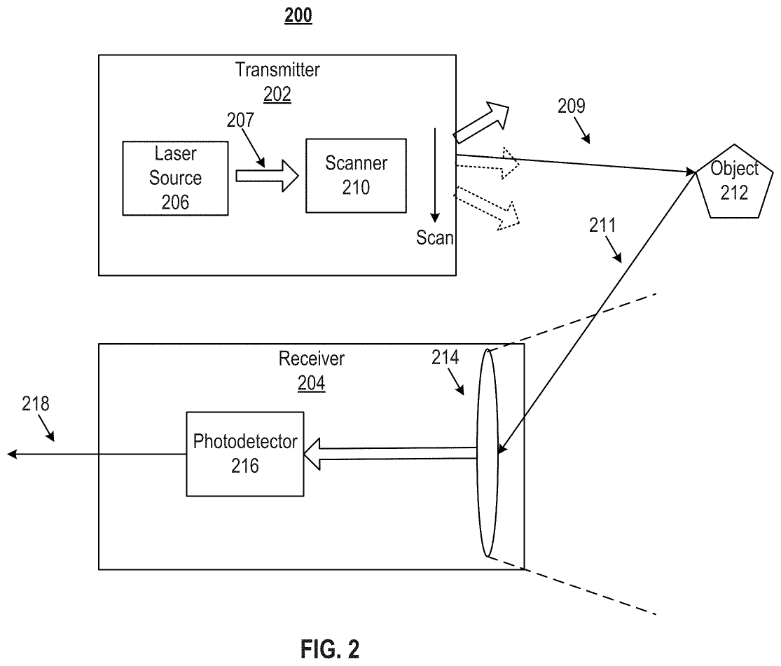

FIG. 2 illustrates a block diagram of an exemplary LiDAR sensing device 200, such as that used in LiDAR system 102. LiDAR sensing device 200 may include a transmitter 202 and a receiver 204. Transmitter 202 may emit laser beams within a scan angle as it rotates. Transmitter 202 may include one or more laser sources 206 and a scanner 210.

In some embodiments, transmitter 202 can sequentially emit a stream of pulsed laser beams in different directions within its scan angle as it rotates, as illustrated in FIG. 2. Laser source 206 may be configured to provide a laser beam 207 (also referred to as a “native laser beam”) in a respective incident direction to scanner 210. In some embodiments of the present disclosure, laser source 206 may generate a pulsed laser beam in the ultraviolet, visible, or near infrared wavelength range.

In some embodiments of the present disclosure, laser source 206 may include a pulsed laser diode (PLD). A PLD may be a semiconductor device similar to a light-emitting diode (LED) in which the laser beam is created at the diode's junction. In some embodiments of the present disclosure, a PLD includes a PIN diode in which the active region is in the intrinsic (I) region, and the carriers (electrons and holes) are pumped into the active region from the N and P regions, respectively. Depending on the semiconductor materials, the wavelength of incident laser beam 207 provided by a PLD may be smaller than 1,100 nm, such as 405 nm, between 445 nm and 465 nm, between 510 nm and 525 nm, 532 nm, 635 nm, between 650 nm and 660 nm, 670 nm, 760 nm, 785 nm, 808 nm, or 848 nm.

Scanner 210 may be configured to emit a laser beam 209 to an object 212 in a first direction. Object 212 may be made of a wide range of materials including, for example, non-metallic objects, rocks, rain, chemical compounds, aerosols, clouds and even single molecules. The wavelength of laser beam 209 may vary based on the composition of object 212. At each time point during the scan, scanner 210 may emit laser beam 209 to object 212 in a direction within the scan angle by rotating a micromachined mirror assembly as the incident angle of incident laser beam 207 may be fixed, as well as rotating moving part 200. In some embodiments of the present disclosure, scanner 210 may also include optical components (e.g., lenses, mirrors) that can focus pulsed laser light into a narrow laser beam to increase the scan resolution and the range to scan object 212.

In some embodiments, receiver 204 may be configured to detect a returned laser beam 211 returned from object 212 in a different direction. Receiver 204 can collect laser beams returned from object 212 and output electrical signal reflecting the intensity of the returned laser beams. Upon contact, laser light can be reflected by object 212 via backscattering, such as Rayleigh scattering, Mie scattering, Raman scattering, and fluorescence. As illustrated in FIG. 2, receiver 204 may include a lens 214 and a photodetector 216. Lens 214 may be configured to collect light from a respective direction in its field of view (FOV). At each time point during the scan, returned laser beam 211 may be collected by lens 214. Returned laser beam 211 may be returned from object 212 and have the same wavelength as laser beam 209.

Photodetector 216 may be configured to detect returned laser beam 211 returned from object 212. Photodetector 216 may convert a laser light (e.g., returned laser beam 211) collected by lens 214 into an electrical signal 218 (e.g., a current or a voltage signal). Electrical signal 218 may be generated when photons are absorbed in a photodiode included in photodetector 216. In some embodiments of the present disclosure, photodetector 216 may include an avalanche photodiode (APD), such as a single photon avalanche diode (SPAD), a SPAD array, or a silicon photo multiplier (SiPM).

While scanner 210 is described herein as part of transmitter 202, it is understood that in some embodiments, scanner 210 can also be included in receiver 204, e.g., before photodetector 216 in the light path. The inclusion of scanner 210 in receiver 204 can ensure that photodetector 216 only captures light, e.g., returned laser beam 211 from desired directions, thereby avoiding interferences from other light sources, such as the sun and/or other LiDAR systems. By increasing the aperture of mirror assembly in scanner 210 in receiver 204, the sensitivity of photodetector 216 can be increased as well.

In some embodiments, LiDAR sensing device 200 may be configured to perform scans in a two-dimensional (2D) FOV. For example, LiDAR sensing device 200 may have a semi-coaxial LiDAR structure in which a Micro-Electro-Mechanical Systems (MEMS) system is used for one-dimensional (1D) scanning as part of transmitter 202. A mechanical system may be used for scanning in another dimension (e.g., a dimension orthogonal to the first dimension). The mechanical system may share a motor with a receiving aperture of receiver 204. Using the semi-coaxial structure, light may be first steered by a MEMS scanner in the x-axis direction, and then be scanned by a galvo system in the y-axis direction orthogonal to the x-axis direction, in a cascaded fashion. Light reflected by an object may be de-scanned in the y-axis direction by the receiving aperture rotated by the same galvo system. The reflected light may then be collected by photodetector 216 (e.g., a detector array). By combining 1D scanning of transmitter 202 with receiver 204, the mechanical part of transmitter 202 can scan at a relatively low rate (e.g., 10 Hz) and thus reduce the power consumption and increase the lifetime and reliability of the system.

In some embodiments, LiDAR sensing device 200 may have a full-coaxial LiDAR structure. Similar to the semi-coaxial LiDAR structure, in the full-coaxial LiDAR structure a MEMS system is used for 1D scanning as part of transmitter 202. A mechanical system is used for scanning in another dimension (e.g., a dimension orthogonal to the first-dimension scanning). The apertures of the MEMS system may also be used as receiving apertures of receiver 204. For example, light may be first steered by a MEMS scanner in the x-axis direction, and then be scanned by the mechanical system (e.g., a galvo system, polygon, flash or rotating mechanical scanner) in the y-axis direction orthogonal to the x-axis direction, in a cascaded fashion. Light reflected by an object may be de-scanned by the MEMS scanner's apertures which are used as receiving aperture rotated by the same MEMS system. The reflected light may then be collected by photodetector 216 (e.g., an avalanche photodiode (APD) or a single-photon avalanche diode (SPAD)).

It is contemplated that the manners in which LiDAR sensing device 200 performs scans are not limited by the examples disclosed herein and may be modified depending on the types of laser source 206, scanner 210, and/or photodetector 216 to achieve desirable sensing performance.

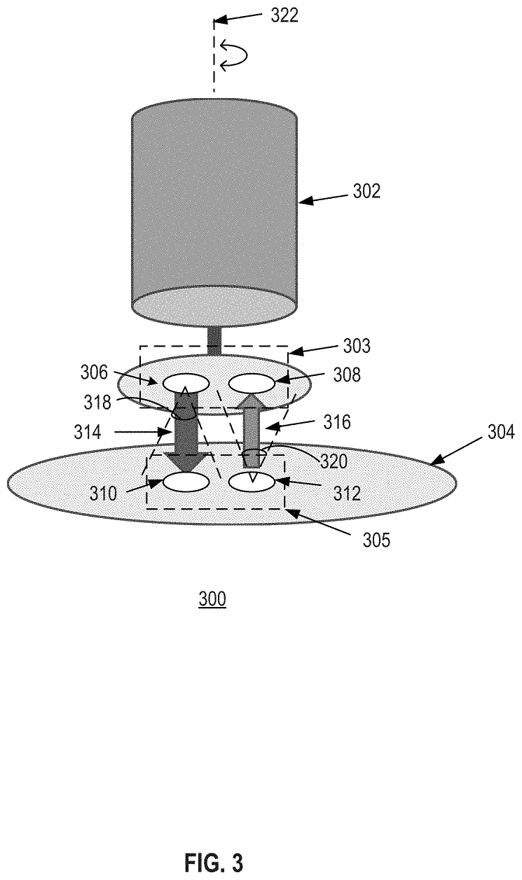

FIG. 3 illustrates a schematic diagram of an exemplary sensing device 300 having a wireless connection between its first and second parts using full-duplex optical data links, according to embodiments of the disclosure. In some embodiments, sensing device 300 may include a LiDAR sensing device, such as LiDAR sensing device 200. In other embodiments, sensing device 300 may include other types of sensing devices different from a LiDAR sensing device, such as a camera-based sensing device having multiple lenses to derive depth information from captured 2D images, a radar-based sensing device using radio frequency (RF) electromagnetic waves to detect range information, or a combination thereof.

As illustrated in FIG. 3, sensing device 300 may include a first part 302 and a second part 304. Part 302 may be a moving part. For example, part 302 may rotate about an axis 322. In some embodiments, part 304 may be a stationary or non-moving part. For example, part 304 may host a mechanical system including, e.g., a motor, a galvo system, a polygon, a flash, and/or a rotating mechanical scanner used for providing motions for 1D scanning and/or de-scanning disclosed above in connection with FIG. 2. In another example, part 304 may host a control or data processing system configured to control the motion of part 302 and/or process signals transmitted from part 302. In some embodiments, part 304 may also move, e.g., rotate, at a different speed from part 302, such that part 302 rotates relative to part 304.

In some embodiments, part 302 may include an optical transceiver 303 that includes at least one light emitter 306 and at least one detector 308. Part 304 may include an optical transceiver 305 that includes at least one light emitter 312 and at least one detector 310. It is understood that the quantity of light emitters and detectors within optical transceivers 303 and/or 305 are not limited to any particular number. For example, a transceiver may include any suitable number of light emitters and detectors. In some embodiments, optical transceivers 303 and 305 may have matching number of light emitters and detectors. For example, optical transceiver 303 may have X light emitters and Y detectors, and optical transceiver 305 may have Y light emitters and X detectors. In other embodiments, the numbers of light emitters and detectors included in optical transceivers 303 and 305 may not be matched. For example, multiple detectors of optical transceiver 305 may be used to detect light signals emitted by one light emitter of optical transceiver 303, and vice versa.

Optical transceivers 303 and 305 may be configured to be wirelessly coupled to each other and simultaneously transmit signals to each other. For example, optical transceivers 303 and 305 may transmit optical signals to each other using the light emitter-detector pairs, thus achieving wireless communication. The wireless connection between parts 302 and 304 avoids the physical contact commonly found in conventional LiDAR sensing devices using slip rings as the means to establish communication between moving and stationary parts. Because no physical abrasion is involved, the lifetime of sensing device 300 can be improved.

Optical transceivers 303 and 305 may be configured to simultaneously transmit signals to each other using non-interfering light signals to achieve full-duplex signal/data communication. For example, light emitters 306 and 312 may emit non-interfering light signals based on different wavelengths to transmit information between parts 302 and 304. Referring to FIG. 3, emitter 306 may be configured to emit a first light signal 314 at a first wavelength such as a wavelength in the ultraviolet range for transmitting signals to detector 310 of part 304. Emitter 312 may be configured to emit a second light 316 at a second wavelength such as a wavelength in the visible light range or infrared range for transmitting signals to detector 308 of part 302. It is understood that other non-interfering wavelength ranges may also be used, as long as the base bands of light signals 314 and 316 are significantly non-overlapping. For example, different colors in the visible light range may be used (e.g., red and blue, red and green, etc.).

Detector 308 and 310 may be configured to detect light signals within differing target wavelength range. For example, detector 308 may be configured to react to or be sensitive to the wavelength of the light signals emitted by light emitter 312, but insensitive to the wavelength of the light signals emitted by light emitter 306. Similarly, detector 310 may be configured to react to or be sensitive to the wavelength of the light signals emitted by light emitter 306, but insensitive to the wavelength of the light signals emitted by light emitter 312. In this way, emission and detection of light signals in both directions (from part 302 to part 304 and from part 304 to part 302) can be simultaneously performed.

In some embodiments, detector 308 and/or 310 may include an optical filter that only permit transmission of light at or close to a target wavelength. For example, when light emitter 306 is configured to emit light signals at a first wavelength and light emitter 312 is configured to emit light signals at a second wavelength that is different from the first wavelength, detector 308 may include an optical filter only permitting transmission of light of the second wavelength or having a wavelength close to the second wavelength, while not permitting transmission of light of the first wavelength of having a wavelength close to the first wavelength. Alternatively or additionally, detector 310 may be similarly configured to only permit transmission of light of the first wavelength or close to the first wavelength, while not permitting transmission of light of the second wavelength or close to the second wavelength. In this way, parts 302 and 304 may simultaneously transmit light signals to each other without interfering each other. For example, part 302 may transmit information related to a sensing signal (e.g., point clouds or data frames collected using transmitter 202 and receiver 204) to part 304 using light 314 at a first wavelength, and part 304 may transmit control or feedback signals (e.g., movement control signals used for scanning a FOV) using light 316 at a second wavelength that is different from the first wavelength. In some embodiments, the first and second wavelength may be sufficiently apart from each other to reduce potential interference and/or to improve the signal-to-noise ratio (SNR).

In some embodiments, information related to the sensing signal may be embedded or encoded in the beam of light 314 using signal processing technologies (e.g., using Orthogonal Frequency Division Multiplexing or other modulation techniques to modulate the frequency, phase, and/or magnitude of the light wave emitted by light emitter 306) and may be transmitted to detector 310. Detector 310 may convert the light signals into a data stream by first converting the light signals into electrical signals and then demodulating the electrical signals into a digital data stream. Control information may be transmitted in a similar manner by light signal 316 from part 304 to part 302. It is noted that the signal transmission between parts 302 and 304 can be in analog or digital form and may or may not involve signal modulation.

It is contemplated that the wavelength of light 314 may be longer than the wavelength of light 316 (e.g., light 314 may be in the range of visible light or infrared range and light 316 may be in the range of ultraviolet), so long as the difference between the wavelengths of light 314 and light 316 permits selective detection by detectors 308 and 310, either based on the intrinsic sensitivities of these detectors or by the transmission properties of the optical filter(s) applied to detector(s) 308 and/or 310. For example, the difference between the wavelengths of light 314 and light 316 can be determined based on the width and/or sharpness of the transition or cutoff region between the maximal and minimal transmission rates of the optical filter(s).

In some embodiments, light emitter 306/312 may be a light source that emits light when current flows through it. For example, emitter 306/312 may be a semiconductor light source (e.g., light-emitting diode emitting low- or high-intensity infrared light, visible-light in different colors, or ultraviolet light) where electrons in the semiconductor recombine with electron holes, releasing energy in the form of photons and thus emit lights. In another example, light emitters 306/312 may be a light source emitting light with strong spatial coherence such as laser. In this case, light emitter 306/312 may emit laser through a process of optical amplification based on the stimulated emission of electromagnetic radiation. In some embodiments, light emitters 306/312 may be an infrared laser source, ultraviolet laser source, X-ray laser source, or gamma-ray laser source. It is contemplated that light emitters 306 and 312 may not be the same type of light source and are not limited to the types of light sources disclosed herein. Any type of light source that can emit light within a relatively narrow wavelength range and have a certain level of intensity that allows transmission of information within a short distance (e.g., the spatial distance between parts 302 and 304) may be used as light emitters 306 and/or 312.

In some embodiments, light emitters 306 and/or 312 may further include a diffractive optical elements (DOE) (not shown) to provide a relatively large/wide free-space signal coverage over the corresponding detector(s). The DOE may include a beam shaper, a beam splitter, and/or a diffuser (also known as homogenizer) where lights 314 and/or 316 may be converted into a multitude of output beams, and the emission angle (e.g., emission angles 318 and/or 320) and/or the light intensity may be controlled. For example, emission angles 318 and/or 320 may be set in a way such that light 314/316 emitted by light emitter 306/312 can cover detector 310/308, respectively, during a full rotation of part 302 relative to part 304. This arrangement can ensure parts 302 and 304 continuously exchange signals during rotations of part 302 relative to part 304.

In some embodiments, detectors 308 and/or 310 may include semiconductor devices that convert light signals into electrical signals (e.g., photodiodes working at different receiving wavelengths). In some embodiments, detectors 308 and/or 310 may include an avalanche photodiode (APD), such as a single photon avalanche diode (SPAD), a SPAD array, or a silicon photo multiplier (SiPM). The electrical signal (e.g., electrical current) can be generated when photons are absorbed in the photodiode. It is contemplated that detectors 308 and/or 310 may or may not be the same type of detecting devices and also not limited to the types of detecting devices disclosed herein. Any type of detecting devices capable of detecting light signal 314 or 316 without being interfered by the other light signal may be used as detectors 308 and/or 310.

In some embodiments, detector 308/310 may include optical filters (not shown) or windows that only allow light signals within a certain range of wavelengths to reach the sensitive part of the detector. For example, detector 310 may include an optical filter that only permits transmission of light 314, and detector 308 may include another optical filter that only permits transmission of light 316. In some embodiments, the optical filter may be an absorptive filter, a dichroic filter, a monochromatic filter, an infrared filter, an ultraviolet filter, or a neutral density filter, etc. For example, the optical filter may be a long-pass optical filter (e.g., passing long-wavelength light only), a short-pass (e.g., passing short-wavelength light only), or a band-pass optical filter (e.g., blocking both longer- and shorter-wavelength lights) to permit transmission of light signals with a certain wavelength. The passband of the filter may be relatively narrow or wide, and the transition or cutoff region between the maximal and minimal transmission rates can be relatively sharp or gradual so long as detector 308 or 310 does not detect (e.g., react to) light signals emitted by the light emitter other than the one paired with the detector (e.g., light emitter 306 is paired with detector 310 and light emitter 312 is paired with detector 308). In some embodiments, the optical filter may also have more than one peak of transmission rate. For example, the transmission rate curve of the optical filter may have two or more peaks.

When exchanging information between parts 302 and 304, even if light 314 may cover detectors other than 310 (e.g., in situations where there are more than one non-pairing detectors in optical transceiver 305) at some point during a full rotation of part 302 relative part 304, fully covering other non-pairing detectors during the full rotation, or transmitting light signals to other detectors of transceiver 303 by reflection (e.g., reflected by components within sensing device 300), the optical filter covering the non-pairing detector(s) may prevent the non-pairing detector(s) from receiving the light signals carried by light 314. The same mechanism applies to the transmission of light 316 and other lights that may carry signals and may be transmitted between parts 302 and 304.

Because detectors 308 and 310 only respond to lights emitted by the corresponding/paired light emitters (e.g., light emitters 306 and 312, respectively) based on the wavelength of the lights, parts 302 and 304 may simultaneously transmit signals to each other using non-interfering communication links established between paired detectors and light emitters (e.g., a first communication link between light emitter 306 and detector 310 and a second communication link between light emitter 312 and detector 308).

In some embodiments, parts 302 and 304 may also use lights 314 and/or 316 for wireless power transfer. For example, light emitters 306 and/or 312 may convert electrical power into optical power for transmission of energy. Detectors 308 and/or 310 may convert the optical power back to electrical power, such as DC or AC electric current which may drive electrical loads.

As illustrated in FIG. 3, parts 302 and 304 may each include a planar surface configured to face each other. In this case, optical transceiver 303 may be disposed on the planar surface of part 302 and optical transceiver 305 may be disposed on the planar surface of part 304, such that optical transceivers 303 and 305 are facing each other during the relative rotation between parts 302 and 304. Detector 308 of optical transceiver 303 may be covered by light 316 emitted by light emitter 312 during a full rotation of part 302 relative to part 304. Similarly, detector 310 of optical transceiver 305 may be covered by light 314 emitted by light emitter 306 of optical transceiver 303 during a full rotation of part 302 relative to part 304. As a result, optical transceivers 303 and 305 may continuously transmit signals to each other during the full rotation of part 302 relative to part 304.

It is contemplated that parts 302 and 304 may both rotate but with different speed. In some embodiment, part 302 may rotate around axis 322 faster than part 304. In other embodiments, part 302 may rotate around axis 322 slower than part 304. In some embodiments, part 302 may rotate around axis 322 in an opposite direction than part 304 (e.g., part 302 rotates clockwise and part 304 rotates counter-clockwise). In some embodiments, part 302 may be stationary while part 304 may rotate around axis 322.

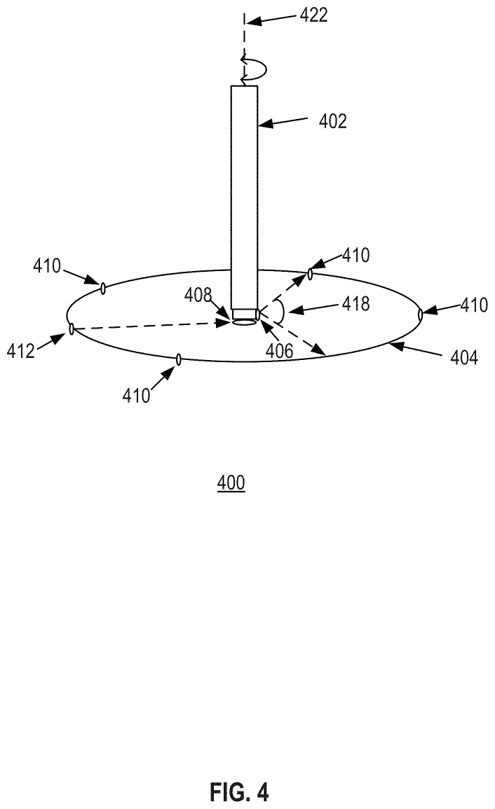

FIG. 4 illustrates a schematic diagram of another exemplary sensing device 400, according to embodiments of the disclosure. As illustrated in FIG. 4, sensing device 400 may include a first part 402 and a second part 404. Part 404 may be in a donut shape, surrounding part 402. In some embodiments, sensing device 400 may include light emitters 406 and 412, which may be similar to light emitters 306 and 312, respectively. Sensing device 400 may also include detector 408 on part 402 and one or more detectors 410 on part 404. Detector 408/410 may be similar to detector 308 or 310. Detector 408 may include a lens gathering lights from a wide range of angles, such as a 360-degree range. Light emitter 412 may emit light toward the center of the donut-shaped part 404 such that detector 408 may receive the light emitted by light emitter 412 continuously during a full rotation of part 402 relative to part 404. Detector 410 may be similar to detector 308 or 310. In some embodiments, part 404 may have more than one detector 410 arranged along an inner surface of part 404 for detecting light emitted by light emitter 406. For example, the number and position of detectors 410 disposed on part 404 and an emission angle 418 of light emitted by light emitter 406 may be set in a manner that during a full rotation of part 402 relative to part 404, at least one of the detectors 410 is covered by the light emitted by light emitter 406. For example, as illustrated in FIG. 4, part 404 may include four detectors 410 evenly disposed on the inner surface of part 404. The emission angle 418 may be set to be larger than 90 degree (e.g., 100 degrees, 105 degrees, 120 degrees, etc.).

It is contemplated that the number and position of detectors 410 disposed on part 404 and emission angle 418 are not limited by the example shown in FIG. 4 and may be modified depending on the types of light emitter 406 and detectors 410 to achieve desirable detecting performance.

In some embodiments, parts 402 and 404 may also be configured to wirelessly transfer power, similar to the manner discussed above in connection with FIG. 3.

In some embodiments, part 402 may have a donut shape surrounding part 404. Full-duplex wireless signal and/or power transmission may be accomplished in a manner similar to those discussed above in connection with FIGS. 3 and 4. For example, part 402 may have more than one detector to receive lights emitted by light emitter(s) disposed on part 404.

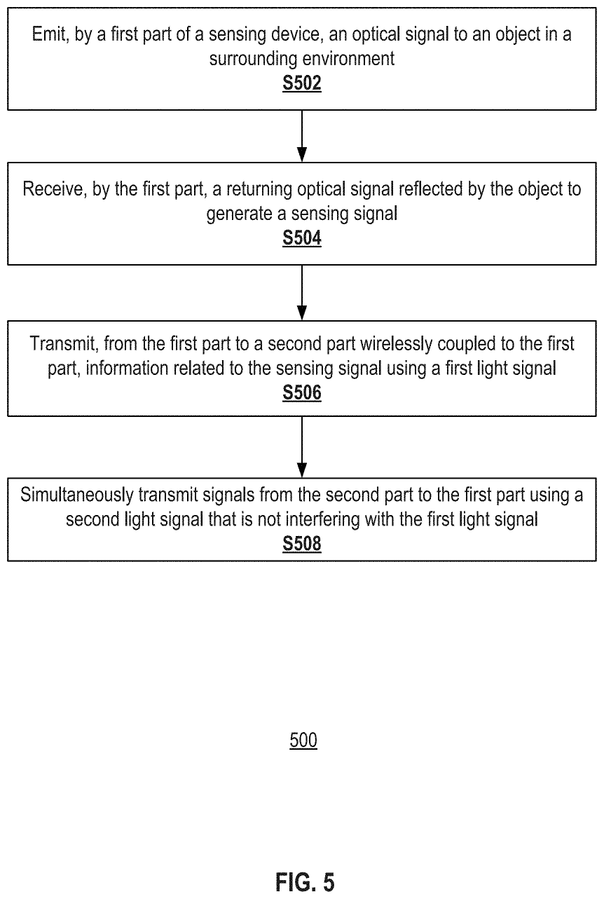

FIG. 5 illustrates a flow chart of an exemplary method 500 for information exchange within a sensing device, according to embodiments of the disclosure. Method 500 may be performed by sensing device 200, 300, or 400, or other suitable sensing devices having two or more parts that have relative motion between different parts, such as a LiDAR device. As shown in FIG. 5, method 500 includes steps S502-S508. In some embodiments, method 500 may include additional steps or may omit one or more of steps S502-S508. In some embodiments, steps S502-S508 may be performed in different orders from the example shown in FIG. 5.

In step S502, transmitter 202 may emit an optical signal (e.g., laser beam 209) to an object (e.g., object 212) in the surrounding environment. Transmitter 202 may be included in part 302 that is rotating relative to part 304. As discussed above in connection with FIG. 2, transmitter 202 may include a scanner 210 to scan the surrounding environment, in which object 212 may be located. In some embodiments, scanner 210 may use a mechanical system to scan a first (e.g., slow) axial and may use a MEMS system to scan a second (e.g., fast) axial, which may be orthogonal to the first axial, to form a 2D FOV. Object 212 within the 2D FOV may reflect laser beam 209 back to, e.g., sensing device 200.

In step S504, receiver 204 may receive a returning optical signal (e.g., returned laser beam 211) reflected by object 212 to generate a sensing signal (e.g., electrical signal 218). For example, receiver 204 may include at least one photodetector 216, which may generate electrical signal 218 by converting photons in beam 211 into electrons. In some embodiments, receiver 204 may be included in part 302 that is rotating relative to part 304.

In step S506, a first optical transceiver (e.g., optical transceiver 303) disposed on part 302 of sensing device 300 may transmit information related to sensing signal 218 (e.g., point clouds or data frames collected using transmitter 202 and receiver 204) to a second optical transceiver (e.g., optical transceiver 305) disposed on part 304 of sensing device 300. As discussed above, parts 302 and 304 may be wirelessly coupled to each other by means of light signal communication (e.g., using light signals 314, 316). In some embodiments, optical transceiver 303 may use emitter 306 to emit a first light signal (e.g., light signal 314) at a first wavelength (e.g., a wavelength in the ultraviolet range) for transmitting the information related to sensing signal 218 to a detector (e.g., detector 310) of transceiver 305 disposed on part 304. For example, the information related to sensing signal 218 may be embedded or encoded in the first light signal (e.g., light signal 314) using signal processing technologies discussed above in connection with FIG. 3.

In step S508, optical transceiver 305 may simultaneously transmit signals (e.g., control or feedback signals related to scanning a FOV) to optical transceiver 303 using a second light signal (e.g., light signal 316) that is not interfering with the first light signal (e.g., light signal 314). For example, optical transceiver 305 may use emitter 312 to emit the second light signal 316 at a second wavelength (e.g., in the visible and/or infrared range) that is different from the first wavelength for transmitting the signals to transceiver 303 of part 302. In some embodiments, emitter 312 may use a light emission mechanism similar to that of emitter 306.

In some embodiments, transceivers 303 and 305 may use detector 308 and 310 to simultaneously detect light signals 316 and 314, respectively, to achieve full-duplex data exchange and/or information communication between parts 302 and 304. In some embodiments, detector 308 may include an optical filter that only permits the transmission of light signal 316. In some embodiments, the optical filter of detector 308 may block the transmission of light signal 314. Similarly, detector 310 may include an optical filter that only permits transmission of light signal 314 or blocks the transmission of light signal 316.

In some embodiments, detectors 308 and 310 may be configured to detect light signals within differing target wavelength ranges. For example, detector 308 may be configured to react to or be sensitive to the wavelength of the light signals emitted by light emitter 312, but insensitive to the wavelength of the light signals emitted by light emitter 306. Similarly, detector 310 may be configured to react to or be sensitive to the wavelength of the light signals emitted by light emitter 306, but insensitive to the wavelength of the light signals emitted by light emitter 312. In this way, emission and detection of light signals in both directions (from part 302 to part 304 and from part 304 to part 302) can be simultaneously performed without substantive interference.

It is to be contemplated that even though emitter 306 may be configured to emit a first light signal 314 at a first wavelength such as a wavelength in the ultraviolet range for transmitting signals to detector 310 of part 304, and emitter 312 may be configured to emit a second light signal 316 at a second wavelength such as a wavelength in the visible light range or infrared range for transmitting signals to detector 308 of part 302, other non-interfering wavelength ranges may also be used, as long as the base bands of light signals 314 and 316 are significantly non-overlapping. For example, different colors in the visible light range may be used (e.g., red and blue, red and green, etc.).

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A sensing device, comprising:
a first optical transceiver disposed on a first part of the sensing device; and
a second optical transceiver disposed on a second part of the sensing device,
wherein:
the first and second optical transceivers are configured to be wirelessly coupled to each other and simultaneously transmit signals to each other; and
the first part is configured to rotate relative to the second part.

2. The sensing device of claim 1, wherein the first and second optical transceivers are configured to simultaneously transmit signals to each other using non-interfering light signals.

3. The sensing device of claim 1, wherein:
the first optical transceiver comprises a first light emitter configured to emit a first light signal at a first wavelength; and
the second optical transceiver comprises a second light emitter configured to emit a second light signal at a second wavelength, the second wavelength being different from the first wavelength.

4. The sensing device of claim 3, wherein:
the first optical transceiver comprises a first detector configured to detect the second light signal at the second wavelength; and
the second optical transceiver comprises a second detector configured to detect the first light signal at the first wavelength.

5. The sensing device of claim 4, wherein at least one of the first or second detector comprises an optical filter permitting transmission of light of the first or second wavelength.

6. The sensing device of claim 1, wherein the first and second optical transceivers are configured to continuously transmit signals to each other during a full rotation of the first part relative to the second part.

7. The sensing device of claim 1, wherein the first and second parts each comprises a planar surface configured to face each other.

8. The sensing device of claim 1, wherein at least one of the first or second part is in a donut shape, surrounding the other part.

9. A method for information exchange within a sensing device, the method comprising:
transmitting, by a first optical transceiver disposed on a first part of the sensing device, information related to a sensing signal to a second optical transceiver disposed on a second part of the sensing device; and
simultaneously receiving, by the first optical transceiver, signals transmitted from the second optical transceiver,
wherein:
the first and second optical transceivers are configured to be wirelessly coupled to each other; and
the first part is configured to rotate relative to the second part.

10. The method of claim 9, comprising:
transmitting, by the second optical transceiver, the signals to the first optical transceiver using light signals not interfering with the transmission of the information by the first optical transceiver.

11. The method of claim 9, comprising:
emitting, by a first light emitter of the first optical transceiver, a first light signal at a first wavelength; and
emitting, by a second light emitter of the second optical transceiver, a second light signal at second wavelength, the second wavelength being different from the first wavelength.

12. The method of claim 11, comprising:
detecting, by a first detector of the first optical transceiver, the second light signal at the second wavelength; and
detecting, by a second detector of the second optical transceiver, the first light signal at the first wavelength.

13. The method of claim 12, wherein at least one of the first or second detector comprises an optical filter permitting transmission of light of the first or second wavelength.

14. The method of claim 9, comprising:
continuously exchanging data between the first and second optical transceivers during a full rotation of the first part relative to the second part.

15. A sensing system, comprising:
a first part, comprising:
at least one optical sensor configured to scan a surrounding environment of the sensing device by emitting an optical signal to an object in the surrounding environment;
at least one photo detector configured to receive a returning optical signal reflected by the object to generate a sensing signal;
a first optical transceiver configured to communicate information related to the sensing signal with a second part of the sensing device; and
the second part, comprising:
a second optical transceiver configured to wirelessly coupled to the first optical transceiver to communicate the information related to the sensing signal,
wherein:
the first and second optical transceivers are configured to simultaneously transmit data to each other; and
the first part is configured to rotate relative to the second part.

16. The sensing system of claim 15, wherein the first and second optical transceivers are configured to simultaneously transmit data to each other using non-interfering light signals.

17. The sensing system of claim 15, wherein:
the first optical transceiver comprises a first light emitter configured to emit a first light signal at a first wavelength; and
the second optical transceiver comprises a second light emitter configured to emit a second light signal at a second wavelength, the second wavelength being different from the first wavelength.

18. The sensing system of claim 17, wherein:
the first optical transceiver comprises a first detector configured to detect the second light signal at the second wavelength; and
the second optical transceiver comprises a second detector configured to detect the first light signal at the first wavelength.

19. The sensing system of claim 15, wherein the first and second optical transceivers are configured to continuously transmit signals to each other during a full rotation of the first part relative to the second part.

20. The sensing system of claim 15, comprising a Light Detection and Ranging (LiDAR) device.
